(19) United States
(12) Patent Application Publication
(10) Pub. No.: US 2026/0253990 A1
(43) Pub. Date: Aug. 27, 2026

(54) AIR-COOLED BATTERY DUCT AND BATTERY SYSTEM FOR VEHICLE

(71) Applicants: Hyundai Motor Company, Seoul (KR); Kia Corporation, Seoul (KR)

(72) Inventor: Seon Ung Youn, Hwaseong-si (KR)

(21) Appl. No.: 19/293,780

(22) Filed: Aug. 7, 2025

(30) Foreign Application Priority Data
Feb. 24, 2025 (KR) 10-2025-0023895

(51) Int. Cl. H01M 10/6563; B60K 6/28; H01M 10/613; H01M 10/625; H01M 50/249

(52) U.S. Cl. CPC H01M 10/6563; B60K 6/28; H01M 10/613; H01M 10/625; H01M 50/249; B60Y 2200/92; H01M 2220/20

(57) ABSTRACT

An air-cooled battery duct for a vehicle includes: a pipe defining a space through which air flows, where a first end of the pipe is connected to a battery pack of the vehicle and in communication with an interior of the battery pack; a discharge port configured to discharge foreign substances from the pipe; a discharge wall extending from a periphery of the discharge port into an inner space of the pipe, allowing the foreign substances in the pipe to accumulate to a predetermined height and then to be discharged through the discharge port; and a cover formed on the upper panel corresponding to the discharge port and covering an upper end of the discharge wall. The air-cooled battery duct is part of an air-cooled system, which allows foreign substances to be smoothly discharged to the exterior without intruding into the interior of a battery pack of the vehicle.

### CROSS-REFERENCE TO RELATED APPLICATION(S)

This application claims under 35 U.S.C. § 119(a) the benefit of Korean Patent Application No. 10-2025-0023895, filed on Feb. 24, 2025 in the Korean Intellectual Property Office, the entire contents of which are incorporated by reference herein.

### BACKGROUND

### 1. Technical Field

The present disclosure relates to an air-cooled battery duct and a battery system for a vehicle, more particularly, to the air-cooled battery duct which allows foreign substances to be smoothly discharged to an exterior of the duct without intruding into an interior of a battery pack of the vehicle.

### 2. Description of the Related Art

High-voltage batteries are installed in electric vehicles, hybrid vehicles, fuel cell vehicles, or the like, and are used as a power source. These batteries require cooling, and depending on the difference in heat generation or battery performance, cooling may be achieved by using either a liquid refrigerant or air.

For example, hybrid vehicles require less battery energy than electric vehicles and need to be equipped with a battery together with an internal combustion engine. Therefore, a relatively small battery pack is used. In addition, there may be differences in battery materials. Accordingly, since heat generation of the battery pack in a hybrid vehicle is relatively lower than that in an electric vehicle, the battery pack may be cooled using air, without using a separate liquid refrigerant such as coolant.

When cooling the battery pack using air, the air inlet or outlet of the battery duct may be located inside or outside the vehicle.

In such a case, foreign substances may be introduced into the battery duct, and since the battery duct is connected to the battery pack of the vehicle, the introduced foreign substances may enter the battery pack.

Accordingly, when foreign substances enter the battery duct, there is a need to remove the introduced foreign substances before they reach the battery pack.

The foregoing described as the background art is intended merely to aid in the understanding of the background of the present disclosure, and is not intended to mean that the present disclosure falls within the purview of the related art already known to those skilled in the art.

### SUMMARY

The present disclosure provides an air-cooled battery duct for a vehicle, which allows foreign substances, when introduced into the air-cooled battery duct, to be smoothly discharged to the exterior of the duct without intruding into the interior of a battery pack of the vehicle.

The technical subjects pursued in the present disclosure may not be limited to the above-mentioned technical subjects, and other technical subjects which are not mentioned may be clearly understood from the following descriptions by those skilled in the art to which the present disclosure pertains.

According to the present disclosure, an air-cooled battery duct for a vehicle includes: a pipe including at least a lower panel and an upper panel that define a space through which air flows, wherein a first end of the pipe is connected to a battery pack of the vehicle and in communication with an interior of the battery pack; a discharge port formed in the lower panel of the pipe and configured to discharge foreign substances from the pipe; a discharge wall extending from a periphery of the discharge port in the lower panel into an inner space of the pipe, allowing the foreign substances in the pipe to accumulate to a predetermined height and then to be discharged through the discharge port; and a cover formed on the upper panel corresponding to the discharge port and covering an upper end of the discharge wall.

According to another aspect of the present disclosure, an air-cooled battery duct for a vehicle according to the present disclosure includes: a pipe formed by coupling a lower panel and an upper panel to define therein a space through which air flows, a first end of the pipe being connected to a battery pack of the vehicle and in communication with an interior of the battery pack; a discharge port formed in the lower panel and configured to discharge foreign substances from the pipe; a discharge wall extending upward in a columnar shape from a periphery of the discharge port in the lower panel into an inner space of the pipe, allowing the foreign substances in the pipe to accumulate to a predetermined height and then to be discharged through the discharge port; and a cover formed on the upper panel, the cover extending downward into the inner space of the pipe at a position corresponding to the discharge port and covering an upper end of the discharge wall while being spaced from the upper end.

The cover may extend downward while being spaced from and surrounding an outer side of the discharge wall, and the lower end of the cover may be spaced apart from the lower panel.

The discharge wall may have a columnar shape that becomes narrower along a direction toward an upper side.

The cover may have a shape that becomes narrower along a direction toward a lower side.

The lower panel may include a reinforcing portion extending upward along the discharge wall at a position adjacent to the discharge port.

The upper panel may include a support portion extending downward toward the lower panel at a portion of the cover.

The support portion may be disposed on an outer side of the discharge wall and partially surrounds the discharge wall.

The lower panel may include a support groove into which the lower end of the support portion is inserted.

The discharge wall may have a portion connected to a support wall, the support groove is defined by the discharge wall and the support wall, and the lower end of the support portion may be inserted into the support groove.

The support portion may be disposed at a side facing a flow direction of air inside the pipe.

The lower panel may include the discharge port disposed at a side opposite to the side of the support portion facing the flow direction of air.

The lower panel may be arranged such that a portion of the lower panel at the first end side of the pipe, which is connected to the battery pack, is higher than a portion of the lower panel at the discharge wall side.

The lower panel is recessed downward in a region including the discharge port to define an accumulation space.

The pipe may be bent such that the first end is positioned lower than a second end.

The second end of the pipe extends in a direction away from the battery pack and is disposed below a seat of the vehicle.

Air flowing through the pipe is introduced into the first end of the pipe from the battery pack and flows through the pipe to be discharged from the second end of the pipe.

The pipe may have an air outlet disposed at the second end of the pipe, and the discharge port, the discharge wall, and the cover are disposed adjacent to the air outlet of the pipe.

A vehicle (for example, an electric vehicle, or more preferably, a hybrid vehicle) may include the air-cooled battery duct.

According to the air-cooled battery duct of the present disclosure, when foreign substances are introduced into the air-cooled battery duct, the introduced foreign substances are smoothly discharged to the exterior of the duct without intruding into the interior of a battery pack of the vehicle.

In addition, since the support portion is provided inside the pipe of the battery duct, the support rigidity of the duct is improved.

Advantageous effects obtainable from the present disclosure may not be limited to the above-mentioned effects, and other effects which are not mentioned may be clearly understood from the following descriptions by those skilled in the art to which the present disclosure pertains.

### BRIEF DESCRIPTION OF THE DRAWINGS

The above and other aspects, features and advantages of the present disclosure will be more apparent from the following detailed description taken in conjunction with the accompanying drawings, in which:

FIG. 1 is a view illustrating an interior of a vehicle in which an air-cooled battery duct for a vehicle is arranged, according to an embodiment of the present disclosure;

FIG. 2 is a view illustrating an air-cooled battery duct for a vehicle coupled to a battery pack of the vehicle, according to another embodiment of the present disclosure;

FIG. 3 is an enlarged cross-sectional view taken along line A-A of FIG. 2;

FIG. 4 is an enlarged view of a discharge port and a support portion of FIG. 3;

FIG. 5 is a view illustrating a lower panel where the discharge port of FIG. 3 is formed; and

FIG. 6 is a view illustrating an upper panel where the support portion of FIG. 3 is formed.

### DETAILED DESCRIPTION OF THE EXEMPLARY EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

In describing the embodiments set forth herein, a detailed description of known functions or configurations incorporated herein will be omitted when it is determined that the description may make the subject matter of the embodiments set forth herein unclear. In addition, it should be appreciated that the accompanying drawings are provided only for the sake of easy understanding of the embodiments set forth herein, and the technical idea of the present disclosure is not limited to the accompanying drawings and includes all modifications, equivalents, or alternatives falling within the spirit and scope of the present disclosure. The following descriptions are not intended to limit the present disclosure to the described form or specific field, and it is considered that various alternative modifications and changes may be made to the present disclosure regardless of whether the descriptions are explicit or implicit. Those skilled in the art to which the present disclosure pertains will appreciate that the contents of the present disclosure may be changed in forms and details.

The present disclosure will be described with reference to specific embodiments. However, as understood by a person ordinarily skilled in the art to which the present disclosure belongs, the various aspects disclosed herein may be modified or otherwise implemented in different ways without departing from the spirit and scope of the present disclosure. Accordingly, the following description is to be considered exemplary, and is intended to teach those ordinarily skilled in the art to which the disclosure belongs how to make and use various embodiments. It is to be understood that the forms of the disclosure illustrated and described herein are exemplary embodiments. Equivalent elements, materials, processes, or steps may be substituted for those exemplified and described in the present disclosure. Expressions used in the present disclosure, such as “including,” “comprising,” “incorporating,” “consisting of,” “having,” or “is,” should be interpreted in a non-exclusive manner, i.e., to allow for the inclusion of items, components, or elements not explicitly listed. In addition, references to the singular form should be interpreted to include the plural form as well.

Furthermore, the various embodiments disclosed herein should be regarded as exemplary and descriptive, and should not be construed as limiting the scope of the present disclosure. All references to joining (e.g., attached, affixed, coupled, and connected) are used solely to facilitate understanding of the present disclosure and are not intended to limit the position, orientation, or use of any component or method disclosed herein. Accordingly, references to joining should be interpreted broadly. Moreover, these references to joining do not imply that two or more elements are directly connected to each other. In addition, all numerical terms, such as “first,” “second,” “third,” “primary,” “secondary,” “main,” or any other generic terms or numerical expressions, are to be understood solely as identifiers to aid in the understanding of the various components, embodiments, modifications, or variations of the present disclosure, and do not imply any limitations as to any component, embodiment, modification, variation, or their order or preference. That is, these terms may be used to describe various components but should not be construed as limiting the components to those terms. These terms are used only to distinguish one component from another.

The terms “module” and “unit” used for the elements in the following description are given or interchangeably used in consideration of only the ease of writing the specification, and do not have distinct meanings or roles by themselves.

In the case where an element is referred to as being “connected” or “coupled” to any other elements, it should be understood that not only the element may be directly connected or coupled to the other elements, but also another element may exist therebetween. Contrarily, in the case where an element is referred to as being “directly connected” or “directly coupled” to any other element, it should be understood that no other element exists therebetween.

In addition, a unit or a control unit included in names is merely a term widely used for naming a controller configured to control a specific function of a vehicle, but does not mean a generic function unit.

In order to control functions in charge, a controller may include a communication device configured to communicate with a sensor or another controller, a memory configured to store an operating system or logic instructions and input/output information, and at least one processor configured to perform determination, calculation, decision or the like required for control of the functions in charge.

Any number or variety of components in any of the configurations described herein may be included within the scope of the present disclosure described herein. The components may include any combination of the features described herein and may be arranged in any of the various configurations described herein. The concepts related to the structure and arrangement of the components of the present disclosure, as well as their use and operation, may be applied to any number of embodiments in any combination, as well as to the specific embodiments discussed herein. Embodiments including those having various features in various arrangements are described below with reference to the drawings.

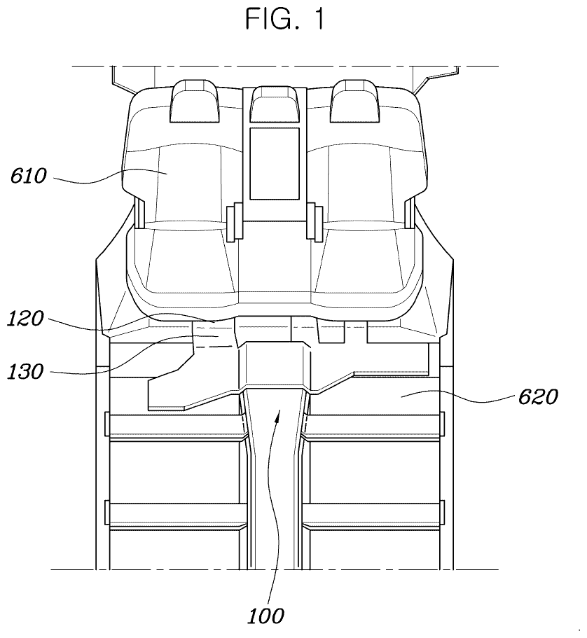

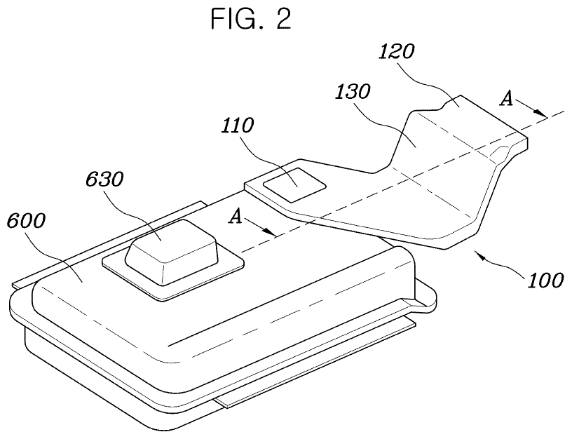

FIGS. 1 and 2 are views illustrating an air-cooled battery duct for a vehicle installed in the vehicle, according to an embodiment and another air-cooled battery duct for a vehicle installed in a battery pack of the vehicle, according to another embodiment.

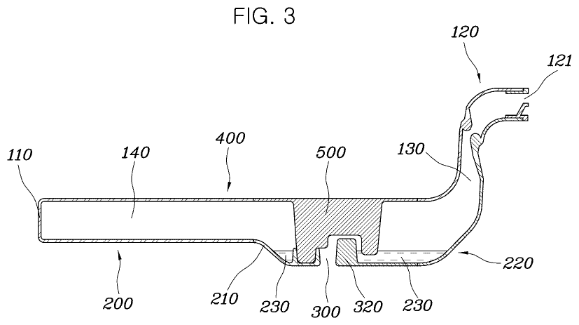

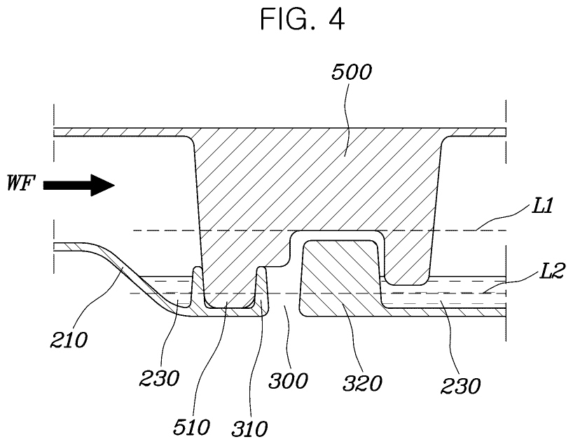

FIG. 3 is an enlarged cross-sectional view of the duct taken along line A-A in FIG. 2, and FIGS. 4 to 6 are enlarged views of a discharge port and a support portion of FIG. 3.

Hereinafter, embodiments set forth herein will be described in detail with reference to the accompanying drawings, and the same or similar elements are given the same and similar reference numerals regardless of figure numbers, so duplicate descriptions thereof will be omitted.

An air-cooled battery duct for a vehicle of the present disclosure includes a pipe 100 formed by coupling a lower panel 200 and an upper panel 400 to define therein a space 140 through which air flows, and a first end 110 of the pipe 100 is connected to a battery pack 600 of the vehicle to communicate with the interior of the battery pack 600, allowing air to flow through the interior of the battery pack 600 and the interior of the pipe 100.

The lower panel 200 and the upper panel 400 may include at least one of plastic and metal and may be formed using injection molding, extrusion molding, metal processing, additive manufacturing, or blow molding.

As illustrated in FIG. 1, in a vehicle according to an embodiment, the battery pack 600 may be installed below a floor 620 of the vehicle. A duct is installed in the battery pack 600 for air cooling of the battery pack. The air-cooled battery duct is connected to the battery pack 600 and disposed above a floor 620 of the vehicle, and the second end 120 of the pipe extends below a seat 610 of the vehicle.

The vehicle to which the present disclosure is applied may include, for example, a hybrid vehicle, an electric vehicle, or a fuel cell vehicle in which a high-voltage battery is applied. The air-cooled battery duct of the present disclosure may be a duct connected to the battery pack for introducing air into the battery pack or a duct for discharging air from the battery pack.

The illustrated embodiment represents a case in which the air-cooled battery duct is applied to a hybrid vehicle with a relatively small battery pack and functions as a duct for discharging air from the battery pack 600. When the discharge port of an air-discharging duct is disposed in the vehicle interior, the air that has exchanged heat with the battery pack 600 is discharged into the interior space of the vehicle through the duct, thereby assisting interior heating or circulating interior air to improve the efficiency of the interior air-conditioning system. In addition, the second end 120 of the pipe may be formed into multiple branches in various directions inside the vehicle. By branching the pipe 100 in this manner, it is possible to reduce the thickness of the pipe 100 while ensuring a larger cross-sectional area, thereby enabling smooth cooling of the battery.

Referring to FIG. 2, an air-cooled battery duct for a vehicle according to another embodiment is connected to a battery pack 600 of the vehicle through the first end 110 of a pipe. The first end 110 of the pipe is coupled to an air outlet of the battery pack 600, allowing air to be discharged through the second end 120 of the pipe. Conversely, when the first end 110 of the pipe is coupled to an air inlet of the battery pack 600, air may be drawn in through the second end 120 of the pipe and introduced into the interior of the battery pack 600 via the first end 110 of the pipe.

Referring to FIGS. 1 to 3, the pipe 100 may include a bent portion 130 to position the first end 110 and the second end 120 of the pipe at different heights. The floor 620 of the vehicle may be curved such that the second row is positioned higher than the first row to utilize the lower space of the second row. The bent portion 130 is provided to correspond to the curve of the floor 620.

In addition, the second end 120 of the pipe may be disposed below a seat 610 of the second row, where the space beneath the seat 610 is not easily accessible to a vehicle user, thereby preventing the foreign substances from intruding into the pipe 100 even if the foreign substances enter the vehicle interior.

However, even when the second end 120 of the pipe is disposed below the seat 610 of the vehicle, foreign substances may flow from above the seat 610 and enter the second end 120 of the pipe, or foreign substances may flow from a trunk along the floor 620 and enter the second end 120 of the pipe. In particular, a blower may be installed in the battery pack 600 or the duct to allow air to flow inside. When the blower is not operating, the force to discharge air through the second end 120 of the pipe disappears, creating an environment where foreign substances can easily enter.

In addition, when the second end 120 of the pipe is disposed outdoors, foreign substances may enter the pipe 100 due to driving environment or the surrounding environment. Moreover, even when air is drawn in from the vehicle interior, foreign substances may enter through an inlet 630.

To prevent this, a cover for preventing the entry of foreign substances may be placed at the second end 120 of the pipe or at the inlet 630. However, since air needs to flow even when the cover is placed, there is bound to be space in the cover through which foreign substances can move, and as a result, there is a possibility that foreign substances enter the pipe 100. When foreign substances enter the pipe 100 in this manner, there may be a problem in which the foreign substances enter the battery pack 600 connected to the pipe 100.

To address this issue, the air-cooled battery duct for a vehicle of the present disclosure applies a technology for, when foreign substances have entered the pipe 100, discharging the foreign substances 230 in the pipe 100 through a discharge port 300 formed in a lower panel 200 before the foreign substances intrude into the battery pack 600.

Specifically, referring to FIGS. 3 to 6, the discharge port 300 is provided in the lower panel 200. Through this, foreign substances 230 that have entered the pipe 100 are discharged through the discharge port 300. In addition, in the vicinity of the discharge port 300, a discharge wall 310 is provided to extend upward in a columnar shape toward the inner space of the pipe. By providing the discharge wall 310, it is possible to prevent the inflow of foreign substances into the discharge port 300 from the outside of the lower panel 200.

The discharge wall 310 may have a columnar shape that becomes narrower along a direction toward an upper side. When the bottom is wide and the top is narrow, structural stability and load distribution efficiency are improved, enabling more stable support.

Since the discharge port 300 is provided in the lower panel 200, stress may be concentrated around the discharge port 300, reducing the durability of the lower panel 200. To reinforce the structural robustness of the lower panel 200 where the discharge port 300 is provided and the discharge wall 310, a reinforcing portion 320 may be provided on the lower panel 200 to extend upward along the discharge wall 310 at a position adjacent to the discharge port 300.

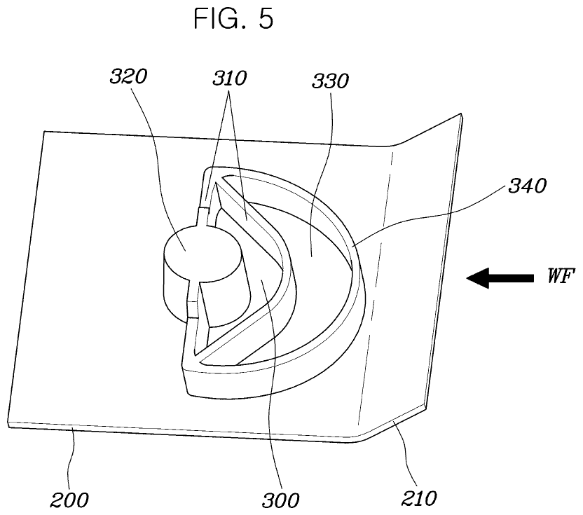

As illustrated in FIG. 5, the reinforcing portion 320 may have a circular cross-section. In addition, the reinforcing portion may have various cross-sectional shapes, such as a polygonal shape, depending on the shape of the discharge port 300.

A cover 500 is provided in the upper panel 400 at a position corresponding to the discharge port 300 to extend downward toward the inner space of the pipe and cover the upper end of the discharge wall 310 while being spaced from the upper end.

Since the lower end of the cover 500 and the upper end of the discharge wall 310 are spaced apart from each other, foreign substances 230 in the pipe may move through the space between the cover 500 and the discharge wall 310 and be discharged through the discharge port 300. In addition, when deformation of the pipe 100 occurs, the discharge wall 310 and the cover 500 may come into contact with each other, thereby preventing deformation of the pipe 100.

The cover 500 may extend downward while surrounding and being spaced from the outer wall of the discharge wall 310, and the lower end of the cover 500 may be spaced apart from the lower panel 200. For example, foreign substances may move through the space between the cover 500 and the discharge wall 310 and be discharged through the discharge port 300.

In addition, as illustrated in FIG. 4, when the cover 500 surrounds the discharge wall 310, if foreign substances 230 in the pipe accumulate above the discharge line L1, the foreign substances are discharged through the discharge port 300. As the foreign substances continue to be discharged and the speed of the foreign substances increases, the pressure in the space between the cover 500 and the discharge wall 310 drops below atmospheric pressure. Due to the siphon effect caused by the differences in speed, gravity, and atmospheric pressure, the discharge of foreign substances 230 continues even when their height falls below the discharge line L1. This continuous discharge stops when the pressure in the space between the cover 500 and the discharge wall 310 equalizes with atmospheric pressure as the height of the foreign substances 230 in the pipe drops below the accumulation line L2, which corresponds to the lower end of the cover 500.

For the discharge of foreign substances, foreign substances 230 in the pipe need to accumulate above the discharge line L1. However, if a large amount accumulates inside the pipe 100, the foreign substances may intrude into the battery pack 600. To prevent this, a step 210 is formed in the lower panel 200 such that the portion of the lower panel closer to the battery pack 600 is higher than the portion of the lower panel at the location where the discharge wall 310 is formed. Due to this step 210, an accumulation space 220 is formed in the lower panel at the location where the discharge wall 310 is formed, allowing the foreign substances 230 in the pipe to accumulate. In addition, the lower panel in the region including the discharge port 300 may be recessed downward to form the accumulation space 220. Even if the foreign substances 230 in the pipe accumulate in the accumulation space 220 and reach above the discharge line L1, the foreign substances 230 are discharged before intruding into the battery pack 600.

The cover 500 may have a shape that becomes narrower along a direction toward a lower side. When the top is wide and the bottom is narrow, structural stability and load distribution efficiency are improved, enabling more stable support.

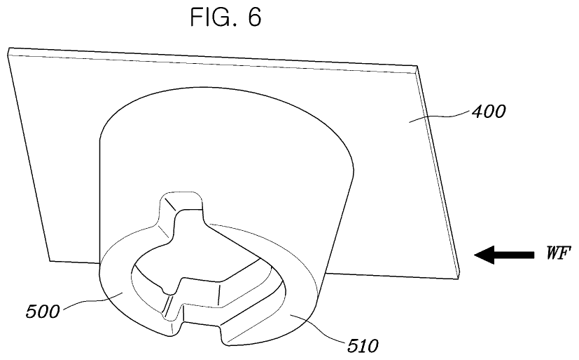

As illustrated in FIG. 6, a portion of the cover 500 may extend further downward toward the lower panel 200 to form a support portion 510. The lower end of the support portion 510 extends to the lower panel 200, allowing the upper panel 400 to be supported by the lower panel 200. A footrest for supporting a vehicle user from the vehicle interior space may be formed on the upper portion of the upper panel 400, allowing for efficient load support in such a case.

To fix the support portion 510, a support groove 330 into which the lower end of the support portion 510 is inserted may be formed in the lower panel 200. In addition, as illustrated in FIG. 5, a support wall 340 may extend upward while being connected to a portion of the discharge wall 310. The support groove 330 may be formed in a space between the discharge wall 310 and the support wall 340, and the lower end of the support portion 510 may be inserted into the support groove 330. When the support portion 510 is inserted into the support groove 330 in this manner, the coupling between the upper panel 400 and the lower panel 200 is facilitated, and the stability of the support portion 510 is also improved.

The support portion 510 may have a shape that surrounds a portion of the discharge wall 310 on the outer side thereof. In particular, as illustrated in FIG. 6, when the outer cross-section of the support portion 510 has a curved shape, the support portion reduces air resistance and occurrence of turbulence inside the pipe 100, thereby maintaining the flow of internal air uniformly, enhancing durability, and reducing noise.

Since air flows inside the pipe 100, when air flows through the gap between the discharge wall 310 and the cover 500, the flow speed may increase in the narrow space, generating a noise such as a whistling sound. When the support portion 510 is formed on a side of the cover 500 that faces the flow direction of air (WF) inside the pipe 100, air is prevented from flowing through the gap between the discharge wall 310 and the cover 500, thereby reducing noise.

In addition, as illustrated in FIG. 4, when the discharge port 300 is formed on the lower panel 200 on the opposite side of the support portion 510 with respect to the flow direction of air (WF), it is possible to prevent problems such as backflow of foreign substances and noise that may occur as air flows over the discharge port 300.

As illustrated in FIG. 3, the discharge port 300, the discharge wall 310, and the cover 500 may be formed at the first end 110 side of the pipe with reference to the bent portion 130. For example, the accumulation space 220 for foreign substances may be formed more broadly.

On the other hand, when the discharge port 300, the discharge wall 310, and the cover 500 are formed on the second end 120 side of the pipe with respect to the bent portion 130 and adjacent to an outlet 121 where air is discharged from the pipe 100, the introduced foreign substances may be accelerated by gravity at the bent portion 130 and discharged through the discharge port 300 before intruding into the battery pack 600.

Although the present disclosure has been described and illustrated in conjunction with particular embodiments thereof, it will be apparent to those skilled in the art that various improvements and modifications may be made to the present disclosure without departing from the technical idea of the present disclosure defined by the appended claims.

What is claimed is:

1. An air-cooled battery duct for a vehicle, the air-cooled battery duct comprising:
a pipe including at least a lower panel and an upper panel that define a space through which air flows, wherein a first end of the pipe is connected to a battery pack of the vehicle and in communication with an interior of the battery pack;
a discharge port formed in the lower panel of the pipe and configured to discharge foreign substances from the pipe;
a discharge wall extending from a periphery of the discharge port in the lower panel into an inner space of the pipe, allowing the foreign substances in the pipe to accumulate to a predetermined height and then to be discharged through the discharge port; and
a cover formed on the upper panel corresponding to the discharge port and covering an upper end of the discharge wall.

2. The air-cooled battery duct of claim 1, wherein the cover extends downward while being spaced from and surrounding an outer side of the discharge wall, and a lower end of the cover is spaced apart from the lower panel.

3. The air-cooled battery duct of claim 1, wherein the discharge wall has a columnar shape that becomes narrower along a direction toward an upper side.

4. The air-cooled battery duct of claim 1, wherein the cover has a shape that becomes narrower along a direction toward a lower side.

5. The air-cooled battery duct of claim 1, wherein the lower panel comprises a reinforcing portion extending upward along the discharge wall at a position adjacent to the discharge port.

6. The air-cooled battery duct of claim 1, wherein the upper panel comprises a support portion extending downward toward the lower panel at a portion of the cover.

7. The air-cooled battery duct of claim 6, wherein the support portion is disposed on an outer side of the discharge wall and partially surrounds the discharge wall.

8. The air-cooled battery duct of claim 6, wherein the lower panel comprises a support groove into which a lower end of the support portion is inserted.

9. The air-cooled battery duct of claim 8, wherein the discharge wall has a portion connected to a support wall, the support groove is defined by the discharge wall and the support wall, and the lower end of the support portion is inserted into the support groove.

10. The air-cooled battery duct of claim 6, wherein the support portion is disposed at a side facing a flow direction of air inside the pipe.

11. The air-cooled battery duct of claim 10, wherein the lower panel comprises the discharge port disposed at a side opposite to the side of the support portion facing the flow direction of air.

12. The air-cooled battery duct of claim 1, wherein the lower panel is arranged such that a portion of the lower panel at the first end side of the pipe, which is connected to the battery pack, is higher than a portion of the lower panel at the discharge wall side.

13. The air-cooled battery duct of claim 1, wherein the lower panel is recessed downward in a region including the discharge port to define an accumulation space.

14. The air-cooled battery duct of claim 1, wherein the pipe is bent such that the first end is positioned lower than the second end.

15. The air-cooled battery duct of claim 1, wherein the second end of the pipe extends in a direction away from the battery pack and is disposed below a seat of the vehicle.

16. The air-cooled battery duct of claim 1, wherein air flowing through the pipe is introduced into the first end of the pipe from the battery pack and flows through the pipe to be discharged from the second end of the pipe.

17. The air-cooled battery duct of claim 1, wherein the pipe has an air outlet disposed at the second end of the pipe, and the discharge port, the discharge wall, and the cover are disposed adjacent to the air outlet of the pipe.

18. An air-cooled battery system for a vehicle, comprising the air-cooled battery duct of claim 1.

19. A vehicle comprising the air-cooled battery duct of claim 1.

20. A hybrid vehicle comprising the air-cooled battery duct of claim 1.
